(19) United States
(12) Patent Application Publication
(10) Pub. No.: US 2023/0385614 A1
(43) Pub. Date: Nov. 30, 2023

(54) DESIGN SPACE REDUCTION APPARATUS, CONTROL METHOD, AND COMPUTER-READABLE STORAGE MEDIUM

(71) Applicant: NEC Corporation, Minato-ku, Tokyo (JP)

(72) Inventor: Salita SOMBATSIRI, Tokyo (JP)

(73) Assignee: NEC Corporation, Minato-ku, Tokyo (JP)

(21) Appl. No.: 18/266,876

(22) PCT Filed: Dec. 23, 2020
(86) PCT No.: PCT/JP2020/048207

§ 371 Date: Jun. 13, 2023

(51) Int. Cl. G06N 3/048

(52) U.S. Cl. CPC G06N 3/048

(57) ABSTRACT

A design space reduction apparatus (2000) acquires original design space information (10) that represents an original design space of an architecture of a target neural network. The design space reduction apparatus (2000) acquires dataset characteristics information (30) that represents characteristics of a target dataset. The target data set is a collection of data to be analyzed by the target neural network. The design space reduction apparatus (2000) generates customized design space information (20) using the original design space information (10) and the dataset characteristics information (30). The customized design space represents a customized design space of the architecture of the target neural network that is narrower than the original design space.

### TECHNICAL FIELD

The present disclosure generally relates to a technique to build neural networks.

### BACKGROUND ART

Neural networks are widely used for various types of tasks. When building a neural network, it is required to determine an architecture thereof, such as types of layers included therein, various hyperparameters, etc.

There are some literatures that disclose techniques to automatically determine an architecture of a neural network to build. PTL1 discloses a technique to determine architectural parameters of a neural network based on characteristics of input data. PTL2 discloses a neural architecture search (NAS) system that searches a space of possible architectures of neural networks, thereby determining an architecture of a neural network to build.

NPL1 discloses a NAS system that employs reinforcement learning to generate hyperparameters of a neural network. NPL2 discloses a technique to extend the NAS system disclosed by NPL1 for mobile devices.

### CITATION LIST

### Patent Literature

PTL1: US patent application publication No. US2020/0175378
PTL2: US patent application publication No. US2020/0257961

### Non Patent Literature

NPL1: Barret Zoph and Quoc V. Le, “Neural Architecture Search with Reinforcement Learning”, Computer Research Repository, arXiv:1611.01578v1, Nov. 5, 2016
NPL2: Mingxing Tan, Bo Chen, Ruoming Pang, Vijay Vasudevan, Mark Sandler, Andrew Howard, and Quoc V. Le, “MnasNet: Platform-aware neural architecture search for mobile”, Computer Research Repository, arXiv:1807.11626v1, Jul. 31, 2018

### SUMMARY OF INVENTION

### Technical Problem

Finding out an appropriate architecture from a broad design space of neural networks is a time-consuming process even if it is automatically performed by a computer. An objective of the present disclosure is to provide a technique to reduce time to find out an appropriate architecture of a neural network.

### Solution to Problem

The present disclosure provides a design space reduction apparatus that comprises at least one processor and memory storing instructions. The at least one processor is configured to execute the instructions to: acquire original design space information representing an original design space of an architecture of a target neural network; acquire dataset characteristics information representing characteristics of a target dataset that is a collection of data to be analyzed by the target neural network; and generate customized design space information representing a customized design space of the architecture of the target neural network using the original design space information and the dataset characteristics information, the customized design space being a design space narrower than the original design space.

The present disclosure provides a control method performed by a computer. The control method comprises: acquiring original design space information representing an original design space of an architecture of a target neural network; acquiring dataset characteristics information representing characteristics of a target dataset that is a collection of data to be analyzed by the target neural network; and generating customized design space information representing a customized design space of the architecture of the target neural network using the original design space information and the dataset characteristics information, the customized design space being a design space narrower than the original design space.

The present disclosure provides a computer-readable storage medium storing a program that causes a computer to perform: acquiring original design space information representing an original design space of an architecture of a target neural network; acquiring dataset characteristics information representing characteristics of a target dataset that is a collection of data to be analyzed by the target neural network; and generating customized design space information representing a customized design space of the architecture of the target neural network using the original design space information and the dataset characteristics information, the customized design space being a design space narrower than the original design space.

### Advantageous Effects of Invention

According to the present disclosure, a technique to reduce time to find out an appropriate architecture of a neural network is provided.

### BRIEF DESCRIPTION OF DRAWINGS

FIG. 1 illustrates an overview of a design space reduction apparatus of the 1st example embodiment.

FIG. 2 is a block diagram illustrating an example of a functional configuration of the design space reduction apparatus.

FIG. 3 is a block diagram illustrating an example of the hardware configuration of a computer realizing the design space reduction apparatus.

FIG. 4 is a flowchart illustrating an example of an overall flow of process performed by the design space reduction apparatus.

FIG. 5 illustrates an example of the original design space information in a table format.

FIG. 6 illustrates the dataset characteristics information in a table format.

FIG. 7 illustrates the predefined knowledge in a table format.

### DESCRIPTION OF EMBODIMENTS

Example embodiments according to the present disclosure will be described hereinafter with reference to the drawings. The same numeral signs are assigned to the same elements throughout the drawings, and redundant explanations are omitted as necessary.

### First Example Embodiment

<Overview>

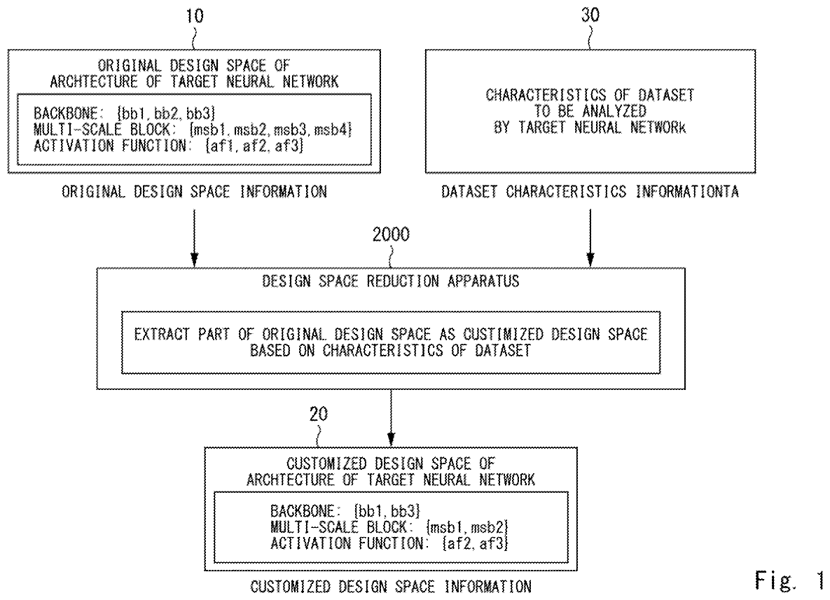

FIG. 1 illustrates an overview of a design space reduction apparatus 2000 of the first example embodiment. Note that the overview illustrated by FIG. 1 shows an example operation of the design space reduction apparatus 2000 to make it easy to understand the design space reduction apparatus 2000, and does not limit or narrow the scope of possible operations of the design space reduction apparatus 2000.

When building a neural network, there are various possible factors of the architecture of the neural network to consider, such as a type of backbone block, a type of multi-scale feature block, a type of layers, a type of activation function, hyperparameters, and so on. Note that the term “block” means a set of layers in this disclosure. The design space reduction apparatus 2000 reduces a possible design space of the architecture of the neural network to be built, based on the characteristics of the dataset to be analyzed by that neural network. Hereinafter, the neural network to be built is described as being “target neural network”. In addition, in this disclosure, “design space” means a set of possible options for the factors of the architecture of the target neural network.

Specifically, the design space reduction apparatus 2000 obtains original design space information 10 and generates customized design space information 20. The original design space information 10 represents an original design space of the architecture of the target neural network. Specifically, the original design space information 10 includes one or more options for each of one or more factors of the architecture of the target neural network 10.

In FIG. 1, the original design space information 10 shows three factors of the architecture of the neural network: a type of backbone block (denoted by “BACKBONE”), a type of multi-scale feature block (denoted by “MULTI-SCALE BLOCK”), and a type of activation function (denoted by “ACTIVATION FUNCTION”). As to the backbone block, the original design space information 10 shows three options: bb1, bb2, and bb3. As to the multi-scale feature block, the original design space information 10 shows four options: msb1, msb2, msb3, and msb4. As to the activation function, the original design space information 10 shows three options: af1, af2, and af3.

The customized design space information 20 represents a customized design space of the target neural network, which is a part of the original design space represented by the original design space information 10. Specifically, the customized design space information 20 includes, for each factor, a part of the options included in the original design space information 10. Thus, for each factor, the number of options included in the customized design space information 20 is equal to or less than the number of options included in the original design space information 10. In addition, regarding at least one factor, the number of options of that factor included in the customized design space information 20 is less than the number of options of that factor included in the original design space information 10.

In FIG. 1, the customized design space information 20 includes the three factors that are also included in the original design space information 10. However, the number of the options for each factor is less than that included in the original design space information 10. Specifically, the options for the backbone block in the customized design space information 20 are bb1 and bb3; bb2 is excluded from the options for the backbone block. The options for the multi-scale feature block in the customized design space information 20 are msb1 and msb2; msb3 and msb4 are excluded from the options for the multi-scale feature block. The options for the activation function in the customized design space information 20 are af2 and af3; af1 is excluded from the options for the activation function.

In the design space reduction apparatus 2000, the customized design space information 20 is generated based on the original design space information 10 and the characteristics of a dataset that is a collection of data to be analyzed by the target neural network (hereinafter, target dataset). For this reason, the design space reduction apparatus 2000 acquires dataset characteristics information 30 that represents the characteristics of the target dataset. Note that the dataset characteristics information 30 may be generated by the design space reduction apparatus 2000 or by another computer.

The design space reduction apparatus 2000 extracts one or more of the options for each factor of the architecture of the target neural network from those included in the original design space information 10, based on the characteristic of the target dataset represented by the dataset characteristics information 30. Then, the design space reduction apparatus 2000 generates the customized design space information 20 that includes the extracted options for each factor of the architecture of the target neural network.

### Example of Advantageous Effect

If a design space of an architecture of the target neural network is broad, it takes much time to find out an appropriate architecture for the target neural network from the design space. Thus, it is preferable to narrow the design space before searching an appropriate architecture for the target neural network. However, if a design space is narrowed without careful consideration, e.g. in a random manner, an appropriate architecture for the target neural network could be removed from the design space, resulting in failing to find out an appropriate architecture for the target neural network.

According to the design space reduction apparatus 2000, the original design space is narrowed taking the characteristics of the target dataset into consideration. Thus, it is possible to narrow the design space while retaining an appropriate architecture for the target neural network in the design space. As a result, when using the customized design space provided by the design space reduction apparatus 2000, it is possible to find out an appropriate architecture for the target neural network in a shorter time than when using the original design space. Note that the customized design space can be used both of the case where the architecture of the target neural network is determined manually and the case where that is determined automatically.

Hereinafter, more detailed explanation of the design space reduction apparatus 2000 will be described.

<Example of Functional Configuration>

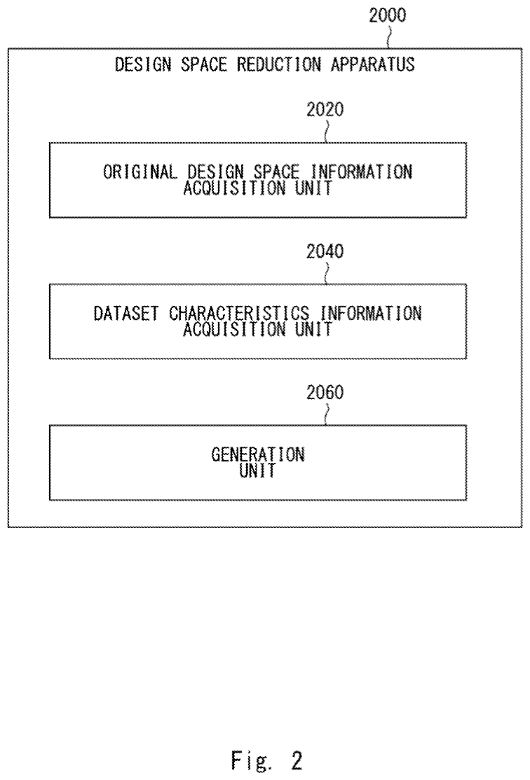

FIG. 2 illustrates an example of a functional configuration of the design space reduction apparatus 2000. The design space reduction apparatus 2000 includes an original design space information acquisition unit 2020, a dataset characteristics information acquisition unit 2040, and a generation unit 2060. The original design space information acquisition unit 2020 acquires the original design space information 10. The dataset characteristics information unit 2040 acquires the dataset characteristics information 30. The generation unit 2060 generates the customized design space information 20 based on the original design space information 10 and the dataset characteristics information 30.

<Example of Hardware Configuration>

The design space reduction apparatus 2000 may be realized by one or more computers. Each of the one or more computers may be a special-purpose computer manufactured for implementing the design space reduction apparatus 2000, or may be a general-purpose computer like a personal computer (PC), a server machine, or a mobile device.

The design space reduction apparatus 2000 may be realized by installing an application in the computer. The application is implemented with a program that causes the computer to function as the design space reduction apparatus 2000. In other words, the program is an implementation of the functional units of the design space reduction apparatus 2000.

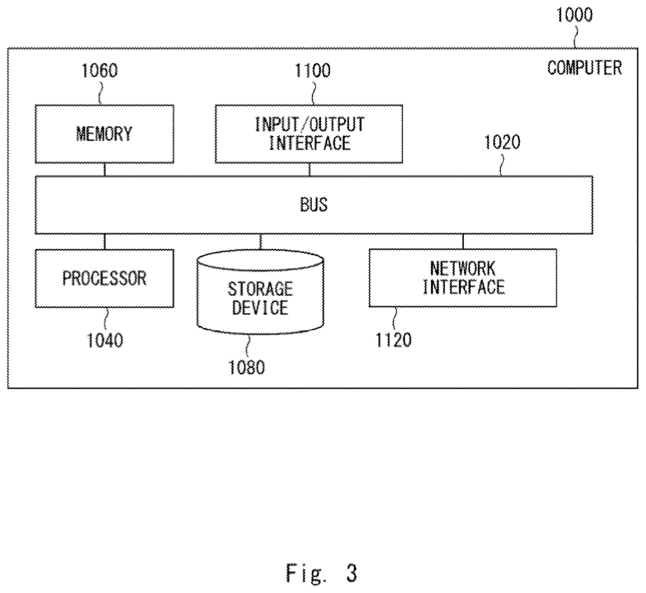

FIG. 3 is a block diagram illustrating an example of the hardware configuration of a computer 1000 realizing the design space reduction apparatus 2000. In FIG. 3, the computer 1000 includes a bus 1020, a processor 1040, a memory 1060, a storage device 1080, an input/output interface 1100, and a network interface 1120.

The bus 1020 is a data transmission channel in order for the processor 1040, the memory 1060, the storage device 1080, and the input/output interface 1100, and the network interface 1120 to mutually transmit and receive data. The processor 1040 is a processer, such as a CPU (Central Processing Unit), GPU (Graphics Processing Unit), or FPGA (Field-Programmable Gate Array). The memory 1060 is a primary memory component, such as a RAM (Random Access Memory) or a ROM (Read Only Memory). The storage device 1080 is a secondary memory component, such as a hard disk, an SSD (Solid State Drive), or a memory card. The input/output interface 1100 is an interface between the computer 1000 and peripheral devices, such as a keyboard, mouse, or display device. The network interface 1120 is an interface between the computer 1000 and a network. The network may be a LAN (Local Area Network) or a WAN (Wide Area Network).

The storage device 1080 may store the program mentioned above. The CPU 1040 executes the program to realize each functional unit of the design space reduction apparatus 2000.

The hardware configuration of the computer 1000 is not limited to the configuration shown in FIG. 3. For example, as mentioned-above, the design space reduction apparatus 2000 may be realized by plural computers. In this case, those computers may be connected with each other through the network.

<Flow of Process>

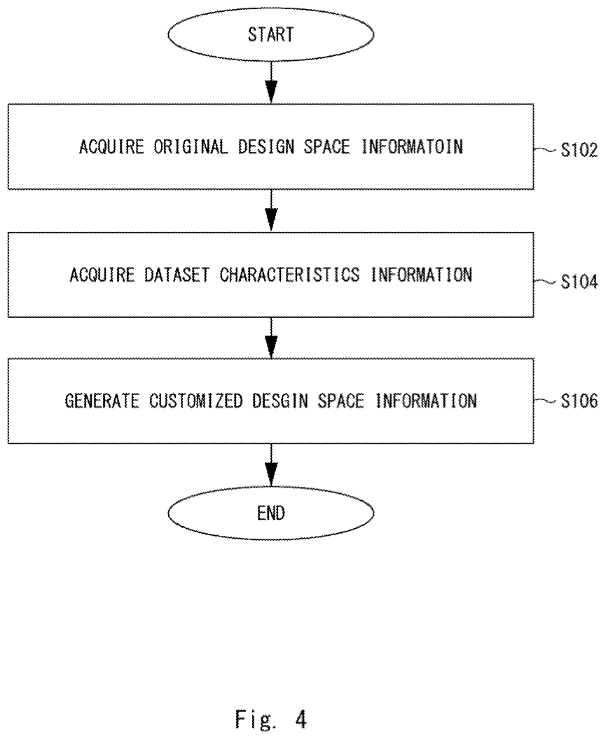

FIG. 4 is a flowchart illustrating an example of a process performed by the design space reduction apparatus 2000. The original design space information acquisition unit 2020 acquires the original design space information 10 (S102). The dataset characteristics information unit 2040 acquires the dataset characteristics information 30 (S104). The generation unit 2060 generates the customized design space information 20 based on the original design space information 10 and the dataset characteristics information 30 (S106).

Note that the flow of the process performed by the design space reduction apparatus 2000 is not limited to that shown in FIG. 4. For example, the acquisition of the dataset characteristics information 30 may be performed earlier than or in parallel with the acquisition of the original design space information 10.

<As to Original Design Space Information>

As described above, when building a neural network, there are various factors of the architecture of the neural network to consider. For example, the type of backbone block, the type of multi-scale feature block, and the type of activation function are examples of the factors to consider as shown in FIG. 1. Specifically, the type of backbone block may include ResNet50, ResNet101, VGG16, etc. The type of multi-scale feature block may include FPN (Feature Pyramid Network), TUM (Thinned U-shape Module), etc. The type of activation function may include ReLU, Sigmoid, etc.

However, there are more possible factors to consider. For example, types of layer can be another factor of the architecture of the target neural network to consider. Specifically, there are a number of types of the layer that can be employed in the target neural network, such as a convolutional layer, recurrent layer, fully-connected layer, pooling layer, normalization layer, and so on. Thus, the original design space information 10 may include all or some of them as the options for the types of layers.

In another example, values of hyperparameters can be other factors to consider. For example, there are various hyperparameters for each type of layer. As to the convolutional layer, the number of groups, the number of kernels (filters), kernel size, stride, and dilation may be the hyperparameters to be employed. As to the recurrent layer, cell type and the number of output nodes may be the hyperparameters to be employed. As to fully-connected layer, the number of output nodes may be the hyperparameters to be employed. As to pooling layer, kernel size, stride, and dilation may be the hyperparameters to be employed. The original design space information 10 may include the options of values (e.g. a range of values) for all or some of these hyperparameters.

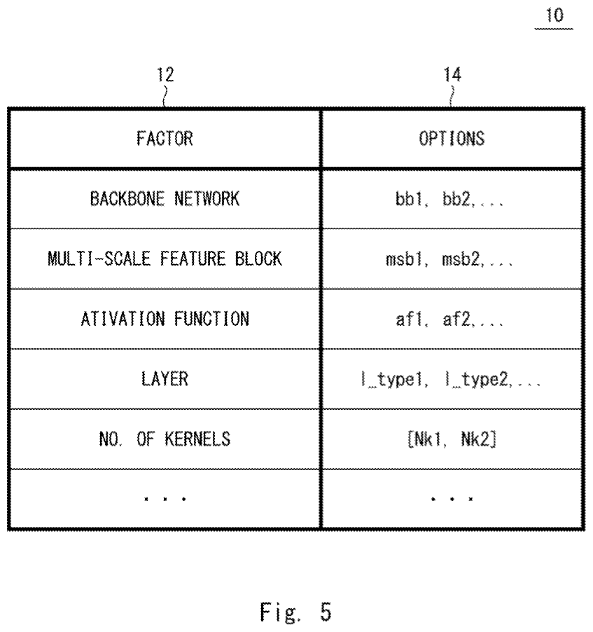

FIG. 5 illustrates an example of the original design space information 10 in a table format. The original design space information 10 includes two columns named “factor 12” and “options 14”. Each cell of the factor 12 includes a factor of the design space. Each cell of the options 14 includes one or more options for the corresponding factor.

<Acquisition of Original Design Space Information: S102>

The original design space information acquisition unit 2020 acquires the original design space information 10 (S102). There are various ways to acquire the original design space information 10. For example, the original design space information acquisition unit 2020 acquires the original design space information 10 from a storage device in which the original design space information 10 is stored in advance and to which the design space reduction apparatus 2000 has access. In another example, the original design space information acquisition unit 2020 receives the original design space information 10 that is sent from another computer.

<As to Dataset Characteristics Information>

The target neural network is to be configured to perform accurate analysis on the target datasets. Thus, an architecture suitable for the target neural network may depend on the characteristic of the target datasets that is to be analyzed by the target neural network. The dataset characteristics information 30 shows one or more characteristics of the target dataset so that the design space reduction apparatus 2000 can know the characteristics of the target dataset.

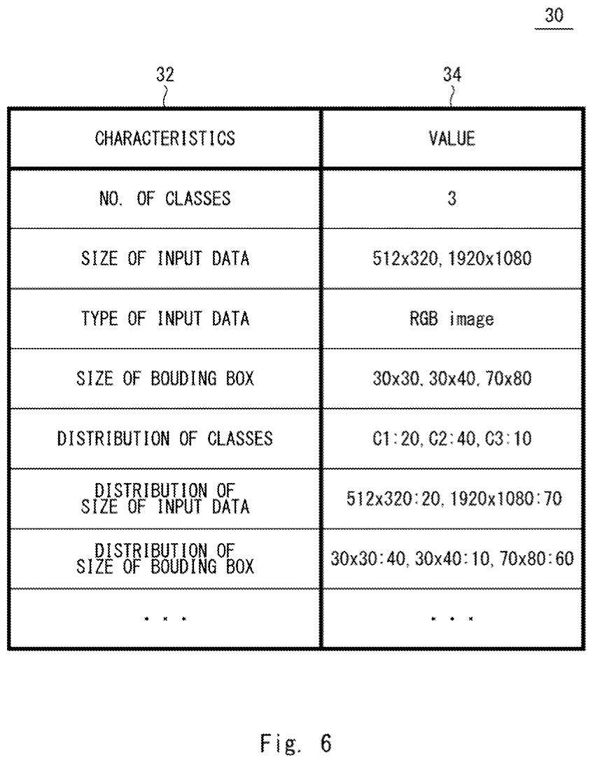

FIG. 6 illustrates the dataset characteristics information 30 in a table format. The dataset characteristics information 30 shown in FIG. 6 includes two columns named “characteristic 32” and “value 34”. Each cell of the characteristic 32 includes a type of the characteristic of the target dataset. Each cell of the value 34 includes one or more values of the corresponding characteristic.

As shown in FIG. 6, there are various types of characteristics of the dataset that would affect the architecture of the target neural network, such as the number of classes, the size of input data, the type of input data, and the size of bounding box. Note that “input data” is each data in the target dataset that is to be input into and analyzed by the target neural network. The characteristic “the number of classes” may be employed in the case where a task to be performed by the target neural network is an object detection or an object classification. Specifically, the number of classes may represent the total number of the classes of objects that are included in the input images in the target dataset. For example, the first record of the dataset characteristics information 30 represents that there are 3 classes of objects in total in the target dataset.

The characteristic “the size of input data” may represent the size of the input data in the target dataset. For example, in the case where the input data is an image data, the size of input data may represent the size of the input images in the target dataset by a combination of the number of pixels in a column and the number of pixels in a row (e.g. 512×320) of the input images. Note that the target dataset may include multiple input data with different sizes. In this case, the size of input data may represent each of those sizes. For example, the second record of the dataset characteristics information 30 shown in FIG. 6 represents that the target dataset includes the input images with the size of 512×320 and those with the size of 1920×1080.

The characteristic “the type of input data” may represent the type of the input data in the target dataset, such as image, audio, etc. In addition, the type of input data may represent more detailed information, such as RGB image and grayscale image. For example, the third record of the dataset characteristics information 30 shown in FIG. 6 represents that the target dataset includes RGB images.

The characteristic “the size of bounding box” may represent the size of bounding box within which an object included in an input image in the target dataset is located. This characteristic is employed in the case where a task to be performed by the target neural network is an object detection. Note that the target dataset may include multiple objects with different sizes. In this case, the size of bounding box may represent each of those sizes. For example, the fourth record of the dataset characteristics information 30 shown in FIG. 6 includes “30×30”, “30×40”, and “70×80” as the values of the size of the bounding box.

A way of representing the numerical characteristics (e.g. the number of classes, the size of input data, and the size of bounding box) is not limited to the methods mentioned above. For example, the numerical characteristics can be represented in a relative manner, such as small, medium, large. Suppose that the number of classes Nc is considered to be large when 10<=Nc, to be medium when 5<=Nc<10, and to be small when Nc<5. In this case, the number of classes shown in FIG. 6 can be described as being “small” instead of “3”.

In addition, the numerical characteristics may be represented using a distribution, such as a histogram or probability mass function. The distribution of the number of classes may represent the number of objects included in the target dataset for each of a plurality of classes. Suppose that the target dataset includes 20 objects belonging to a class C1, 40 objects belonging to a class C2, and 10 objects belonging to a class C3. In this case, the distribution of the number of classes may represent a histogram He={C1: 20, C2: 40, C3: 10}, as shown in the fifth record of the dataset characteristics information 30 in FIG. 6.

The distribution of the size of input data may represent the number of input data for each of a plurality of sizes. Suppose that the target dataset includes 20 input data with the size “512×30”, and 70 input data with the size “1920×1080”. In this case, the distribution of the size of input data may represent a histogram Hsi={512×30: 20, 1920×1080: 70}, as shown in the sixth record of the dataset characteristics information 30 in FIG. 6.

The distribution of the size of bounding box may represent the number of input data for each size of bounding box. Suppose that the target dataset includes 40 objects whose size of the bounding box is “30×30”, 10 objects whose size of the bounding box is “30×40”, and 60 objects whose size of the bounding box is “70×80”. In this case, the distribution of the size of bounding box may represent a histogram Hsb={30×30: 40, 30×40: 10, 70×80: 60}, as shown in the seventh record of the dataset characteristics information 30 in FIG. 6.

The distribution of the characteristics may also be represented in a relative manner. Suppose that the number of bounding boxes Nb is considered to be large when 50<=Nb, to be medium when 20<=Nb<50, and to be small when Nb<20. In this case, the histogram Hsb={30×30: 40, 30×40: 10, 70×80: 60} described above can be converted into a histogram Hsb={30×3: 2, 30×40: 1, 70×80: 3} wherein being large is denoted by 3, being medium is denoted by 2, and being small is denoted by 1.

Note that the histogram can be transformed with other ways, such as [0,1] scaling, zero-mean-unit-variance normalization, percentage or ration, etc.

In addition to the characteristics of the dataset mentioned above, the dataset characteristics information 30 may include a type of task to be performed on the target dataset. The type of task may be object detection, object classification, etc.

<Acquisition of Dataset Characteristics Information: S104>

The dataset characteristics information acquisition unit 2040 acquires the dataset characteristics information 30 (S104). There are various ways to acquire the dataset characteristics information 30. For example, the dataset characteristics information acquisition unit 2040 acquires the dataset characteristics information 30 from a storage device in which the dataset characteristics information 30 is stored in advance and to which the design space reduction apparatus 2000 has access. In another example, the dataset characteristics information acquisition unit 2040 receives the dataset characteristics information 30 that is sent from another computer.

In another example, the dataset characteristics information 30 may be generated by the design space reduction apparatus 2000 itself. In this case, for example, the dataset characteristics information acquisition unit 2040 acquires the dataset characteristics information 30 from a storage device managed by the design space reduction apparatus 2000 (e.g. the storage device 1080).

In the case where the dataset characteristics information 30 is generated by the design space reduction apparatus 2000, the design space reduction apparatus 2000 may acquire a dataset whose characteristics are the same as or similar to those of the target dataset. Hereinafter, the dataset acquired by the design space reduction apparatus 2000 to generate the dataset characteristics information 30 is described as being “representative dataset”. The design space reduction apparatus 2000 analyzes the representative dataset to determine the characteristics of the representative dataset, and generate the dataset characteristics information 30 that represents the characteristics of the representative dataset as those of the target dataset.

The determination of the characteristics of the representative dataset can be performed using well-known techniques. For example, regarding the characteristic “the number of classes”, the design space reduction apparatus 2000 may perform an object classification on each input data in the representative dataset, thereby determining the number of the classes of objects that are detected from the representative dataset. Regarding the characteristic “the size of input data”, the design space reduction apparatus 2000 may extract metadata of each input data that indicates the size thereof, thereby determining one or more sizes of the input data in the representative dataset. Regarding the characteristic “the type of input data”, the design space reduction apparatus 2000 may extract metadata of each input data that indicates the type thereof, thereby determining one or more types of the input data in the representative dataset. Regarding the characteristic “the size of bounding box”, the design space reduction apparatus 2000 may perform an object detection on each input data in the representative dataset, thereby determining one or more sizes of the bounding boxes each of which includes an object detected from the target dataset.

<Generation of Customized Design Space Information: S106>

The generation unit 2060 generates the customized design space information 20 based on the original design space information 10 and the dataset characteristics information 30 (S106). Note that the customized design space 20 may have a structure similar to that of the original design space information 10 depicted by FIG. 5.

Theoretically, the customized design space can be generated by shrinking the original design space based on the characteristics of the target dataset. Hereinafter, some example ways of generating the customized design space information 20 is explained.

<<Using Predetermined Knowledge>>

For example, the generation unit 2060 may compare the original design space information 10 with a predefined knowledge to generate the customized design space information 20. The predefined knowledge may represent an association between the characteristics of the dataset and the design space of the architecture of the neural network that is suitable for the neural network analyzing the dataset with the corresponding characteristics.

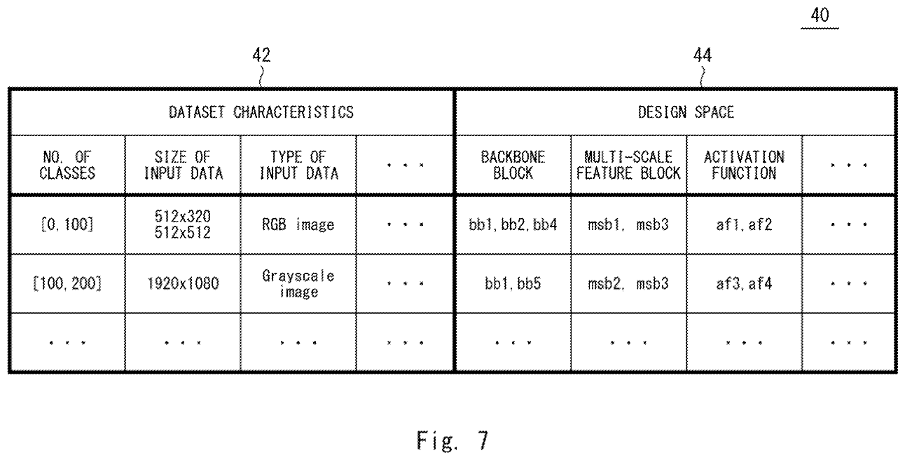

FIG. 7 illustrates the predefined knowledge in a table format. Hereinafter, the table shown in FIG. 7 is described as being “knowledge table 40”. The knowledge table 40 includes two columns named “dataset characteristics 42” and “design space 44”. The design space 44 represents the design space suitable for the target neural network that handles the dataset having the characteristics represented by the corresponding dataset characteristics 42. Note that the representation [Na,Nb] in the knowledge table 40 represents a range between larger than or equal to Na and less than or equal to Nb.

The generation unit 2060 determines the record of the knowledge table 40 whose dataset characteristics 42 matches the characteristics of the target dataset shown in the dataset characteristics information 30. Then, the generation unit 2060 generates the customized design space information 20 that represents the contents of the design space 44 of the determined record.

Note that it is possible that the knowledge table 40 includes the factors or the options of the factors that are not shown in the original design space information 10. In this case, the generation unit 2060 does not put those pieces of information into the customized design space information 20. In other words, the generation unit 2060 put only the factors or the options of the factors that are included in both of the knowledge table 40 and the original design space information 10 into the customized design space information 20. This means that the customized design space is generated as an intersection of the original design space and the design space obtained from the knowledge table.

Suppose that the design space 44 in the record of the knowledge table 40, whose data characteristic 102 is determined to match the dataset characteristics information 30, includes “backbone network”, “multi-scale block”, and “activation function”. On the other hand, the original design space information 10 includes “backbone network” and “multi-scale block” but not “activation function”. In this case, the generation unit 2060 does not put the factor “activation function” into the customized design space information 20.

In addition, suppose that the options of the multi-scale block in the design space 44 are “msb1”, “msb2” and “msb4”, whereas those in the original design space information 20 are “msb1”, “msb2”, and “msb3”. In this case, msb4 is included in the design space 44 but not in the original design space information 20. Thus, the generation unit 2060 does not put the msb4 into the customized design space information 20.

<<Machine Learning-Based Approach>>

In another example, a machine learning-based approach can be employed as a method to generate the customized design space information 20. In this case, a model that is configured to obtain the characteristics of the dataset and output the customized design space is prepared in advance. This model may be trained in advance with a training dataset that associates the characteristics of the dataset and a ground-truth of the customized design space. There are various types of the model that can be employed to generate the customized design space information 20: neural network, SVM (support vector machine), k-Nearest neighbors, etc.

The generation unit 2060 inserts the characteristics of the target dataset that is included in the dataset characteristics information 30 into the model. In response to the characteristics of the target dataset being input to the model, the model outputs the customized design space. Thus, the generation unit 2060 generates the customized design space information 20 that represents the customized design space output from the model. However, the generation unit 2060 may put only the factors or the options of the factors that are included in both of the customized design space output from the model and the original design space information 10 into the customized design space information 20. This means that the customized design space is generated as an intersection of the original design space and the design space obtained from the model.

<Output of Design Space Reduction Apparatus 2000>

The design space reduction apparatus 2000 may output the customized design space 20 in an arbitrary way. For example, the design space reduction apparatus 2000 may put the customized design space 20 into a storage device. In another example, the design space reduction apparatus 2000 may send the customized design space information 20 to another computer.

<Example Application of Customized Design Space Information>

The customized design space information 20 may be used for automatic determination of the architecture of the target neural network. Neural Architecture Search (NAS) is a technique to automatically determine the architecture of a neural network based on predefined design space. Basically, a NAS system repeatedly performs a task sequence of: sampling an architecture of a neural network from the design space; and evaluating the sampled architecture based on a predefined objective function, until the result of the evaluation satisfies the predefined condition. Note that the evaluation of the sampled architecture requires to train a neural network having the sampled architecture, and therefore is a time-consuming task.

If the predefined design space is broad, the NAS system has to repeat the above-mentioned task sequence a lot of times. Thus, it takes much time for the NAS system to find an appropriate architecture for the target neural network from the design space. For this reason, it is preferable to narrow a design space before providing it to the NAS system. However, as mentioned above, if a design space is narrowed without careful consideration, an appropriate architecture for the target neural network could be removed from the design space, resulting in that the NAS system fails to find an appropriate architecture for the target neural network.

According to the design space reduction apparatus 2000, the original design space is narrowed taking the characteristics of the target dataset into consideration. Thus, it is possible to narrow the design space while retaining an appropriate architecture for the target neural network in the design space. As a result, when using the customized design space provided by the design space reduction apparatus 2000, the NAS system can find out an appropriate architecture for the target neural network in a shorter time than when using the original design space.

Although the present disclosure is explained above with reference to example embodiments, the present disclosure is not limited to the above-described example embodiments. Various modifications that can be understood by those skilled in the art can be made to the configuration and details of the present disclosure within the scope of the invention.

The whole or part of the example embodiments disclosed above can be described as, but not limited to, the following supplementary notes.

<Supplementary Notes>

(Supplementary Note 1)

A design space reduction apparatus comprising:
at least one processor; and
memory storing instructions;
wherein the at least one processor is configured to execute the instructions to:
acquire original design space information representing an original design space of an architecture of a target neural network;
acquire dataset characteristics information representing characteristics of a target dataset that is a collection of data to be analyzed by the target neural network; and
generate customized design space information representing a customized design space of the architecture of the target neural network using the original design space information and the dataset characteristics information, the customized design space being a design space narrower than the original design space.

(Supplementary Note 2)

The design space reduction apparatus according to Supplementary Note 1,
wherein the original design space information includes a plurality of options for each of one or more factors of the architecture of the target neural network;
the generation of the customized design space information includes:
   extracting a part of the options for each of the one or more factors; and
   generating the customized design space information that includes the extracted part of the options for each of the one or more factors.

(Supplementary Note 3)

The design space reduction apparatus according to Supplementary Note 1 or 2,
the generation of the customized design space information includes:
   acquiring predefined knowledge that represents a plurality of associations between characteristics of dataset and a design space of an architecture of a neural network;
   extracting, from the predefined knowledge, the design space that is associated with the characteristics of dataset that matches the characteristics of the target dataset represented by the dataset characteristics information; and
   generate the customized design space information based on the design space extracted from the predefined knowledge and the original design space represented by the original design space information.

(Supplementary Note 4)

The design space reduction apparatus according to Supplementary Note 1 or 2,
wherein the memory is further configured to store a model that acquires the characteristics of the target dataset and outputs a design space in response to the characteristics of the target dataset being input into the model,
the generation of the customized design space information includes:
   inserting the characteristics of the target dataset represented by the dataset characteristics information into the model;
   acquire the design space output from the model;
   generate the customized design space information based on the design space output from the model and the original design space represented by the original design space information.

(Supplementary Note 5)

The design space reduction apparatus according to any one of Supplementary Notes 1 to 4,
wherein the at least one processor is further configured to execute:
acquire a representative dataset having characteristics similar to or same as the characteristics of the target datasets; and
determine characteristics of the representative dataset to generate the dataset characteristics information that represents the determined characteristics of the representative dataset as the characteristics of the target dataset.

(Supplementary Note 6)

The design space reduction apparatus according to any one of Supplementary Notes 1 to 5,
wherein the characteristics of the target dataset includes a number of classes, a size of input data, a type of input data, a size of bounding box, a distribution of classes, a distribution of the size of input data, or a distribution of the size of bounding box.

(Supplementary Note 7)

A control method performed by a computer, comprising:
acquiring original design space information representing an original design space of an architecture of a target neural network;
acquiring dataset characteristics information representing characteristics of a target dataset that is a collection of data to be analyzed by the target neural network; and
generating customized design space information representing a customized design space of the architecture of the target neural network using the original design space information and the dataset characteristics information, the customized design space being a design space narrower than the original design space.

(Supplementary Note 8)

The control method according to Supplementary Note 7,
wherein the original design space information includes a plurality of options for each of one or more factors of the architecture of the target neural network;
the generation of the customized design space information includes:
   extracting a part of the options for each of the one or more factors; and
   generating the customized design space information that includes the extracted part of the options for each of the one or more factors.

(Supplementary Note 9)

The control method according to Supplementary Note 7 or 8,
the generation of the customized design space information includes:
   acquiring predefined knowledge that represents a plurality of associations between characteristics of dataset and a design space of an architecture of a neural network;
   extracting, from the predefined knowledge, the design space that is associated with the characteristics of dataset that matches the characteristics of the target dataset represented by the dataset characteristics information; and
   generate the customized design space information based on the design space extracted from the predefined knowledge and the original design space represented by the original design space information.

(Supplementary Note 10)

The control method according to Supplementary Note 7 or 8,
wherein the computer is configured to store a model that acquires the characteristics of the target dataset and outputs a design space in response to the characteristics of the target dataset being input into the model,
the generation of the customized design space information includes:
   inserting the characteristics of the target dataset represented by the dataset characteristics information into the model;
   acquire the design space output from the model;
   generate the customized design space information based on the design space output from the model and the original design space represented by the original design space information.

(Supplementary Note 11)

The control method according to any one of Supplementary Notes 7 to 10, further comprising:
acquiring a representative dataset having characteristics similar to or same as the characteristics of the target datasets; and
determining characteristics of the representative dataset to generate the dataset characteristics information that represents the determined characteristics of the representative dataset as the characteristics of the target dataset.

(Supplementary Note 12)

The control method according to any one of Supplementary Notes 7 to 11,
wherein the characteristics of the target dataset includes a number of classes, a size of input data, a type of input data, a size of bounding box, a distribution of classes, a distribution of the size of input data, or a distribution of the size of bounding box.

(Supplementary Note 13)

A computer-readable storage medium storing a program that causes a computer to perform:
acquiring original design space information representing an original design space of an architecture of a target neural network;
acquiring dataset characteristics information representing characteristics of a target dataset that is a collection of data to be analyzed by the target neural network; and
generating customized design space information representing a customized design space of the architecture of the target neural network using the original design space information and the dataset characteristics information, the customized design space being a design space narrower than the original design space.

(Supplementary Note 14)

The storage medium according to Supplementary Note 13,
wherein the original design space information includes a plurality of options for each of one or more factors of the architecture of the target neural network;
the generation of the customized design space information includes:
   extracting a part of the options for each of the one or more factors; and
   generating the customized design space information that includes the extracted part of the options for each of the one or more factors.

(Supplementary Note 15)

The storage medium according to Supplementary Note 13 or 14,
the generation of the customized design space information includes:
   acquiring predefined knowledge that represents a plurality of associations between characteristics of dataset and a design space of an architecture of a neural network;
   extracting, from the predefined knowledge, the design space that is associated with the characteristics of dataset that matches the characteristics of the target dataset represented by the dataset characteristics information; and
   generate the customized design space information based on the design space extracted from the predefined knowledge and the original design space represented by the original design space information.

(Supplementary Note 16)

The storage medium according to Supplementary Note 13 or 14, further storing:
a model that acquires the characteristics of the target dataset and outputs a design space in response to the characteristics of the target dataset being input into the model,
wherein the generation of the customized design space information includes:
   inserting the characteristics of the target dataset represented by the dataset characteristics information into the model;
   acquire the design space output from the model;
   generate the customized design space information based on the design space output from the model and the original design space represented by the original design space information.

(Supplementary Note 17)

The storage medium according to any one of Supplementary Notes 13 to 16,
wherein the program further causes the computer to perform:
acquiring a representative dataset having characteristics similar to or same as the characteristics of the target datasets; and
determining characteristics of the representative dataset to generate the dataset characteristics information that represents the determined characteristics of the representative dataset as the characteristics of the target dataset.

(Supplementary Note 18)

The storage medium according to any one of Supplementary Notes 13 to 17,
wherein the characteristics of the target dataset includes a number of classes, a size of input data, a type of input data, a size of bounding box, a distribution of classes, a distribution of the size of input data, or a distribution of the size of bounding box.

### REFERENCE SIGNS LIST

10 ORIGINAL DESIGN SPACE INFORMATION
12 FACTOR
14 OPTIONS
20 CUSTOMIZED DESIGN SPACE INFORMATION
30 DATASET CHARACTERISTICS INFORMATION
32 CHARACTERISTICS
34 VALUE
40 KNOWLEDGE TABLE
42 DATASET CHARACTERISTICS
44 DESIGN SPACE
1000 COMPUTER
1020 BUS
1040 PROCESSOR
1060 MEMORY
1080 STORAGE DEVICE
1100 INPUT/OUTPUT INTERFACE
1120 NETWORK INTERFACE
2000 DESIGN SPACE REDUCTION APPARATUS
2020 ORIGINAL DESIGN SPACE INFORMATION ACQUISITION UNIT
2040 DATASET CHARACTERISTICS INFORMATION ACQUISITION UNIT
2060 GENERATION UNIT

What is claimed is:

1. A design space reduction apparatus comprising:
at least one memory storing instructions; and
at least one processor that is configured to execute the instructions to:
acquire original design space information representing an original design space of an architecture of a target neural network;
acquire dataset characteristics information representing characteristics of a target dataset that is a collection of data to be analyzed by the target neural network; and
generate customized design space information representing a customized design space of the architecture of the target neural network using the original design space information and the dataset characteristics information, the customized design space being a design space narrower than the original design space.

2. The design space reduction apparatus according to claim 1,
wherein the original design space information includes a plurality of options for each of one or more factors of the architecture of the target neural network;
the generation of the customized design space information includes:
extracting a part of the options for each of the one or more factors; and
generating the customized design space information that includes the extracted part of the options for each of the one or more factors.

3. The design space reduction apparatus according to claim 1,
the generation of the customized design space information includes:
acquiring predefined knowledge that represents a plurality of associations between characteristics of dataset and a design space of an architecture of a neural network;
extracting, from the predefined knowledge, the design space that is associated with the characteristics of dataset that matches the characteristics of the target dataset represented by the dataset characteristics information; and
generate the customized design space information based on the design space extracted from the predefined knowledge and the original design space represented by the original design space information.

4. The design space reduction apparatus according to claim 1,
wherein the at least one memory is further configured to store a model that acquires the characteristics of the target dataset and outputs a design space in response to the characteristics of the target dataset being input into the model,
the generation of the customized design space information includes:
inserting the characteristics of the target dataset represented by the dataset characteristics information into the model;
acquire the design space output from the model;
generate the customized design space information based on the design space output from the model and the original design space represented by the original design space information.

5. The design space reduction apparatus according to claim 1,
wherein the at least one processor is further configured to execute:
acquire a representative dataset having characteristics similar to or same as the characteristics of the target datasets; and
determine characteristics of the representative dataset to generate the dataset characteristics information that represents the determined characteristics of the representative dataset as the characteristics of the target dataset.

6. The design space reduction apparatus according to claim 1,
wherein the characteristics of the target dataset includes a number of classes, a size of input data, a type of input data, a size of bounding box, a distribution of classes, a distribution of the size of input data, or a distribution of the size of bounding box.

7. A control method performed by a computer, comprising:
acquiring original design space information representing an original design space of an architecture of a target neural network;
acquiring dataset characteristics information representing characteristics of a target dataset that is a collection of data to be analyzed by the target neural network; and
generating customized design space information representing a customized design space of the architecture of the target neural network using the original design space information and the dataset characteristics information, the customized design space being a design space narrower than the original design space.

8. The control method according to claim 7,
wherein the original design space information includes a plurality of options for each of one or more factors of the architecture of the target neural network;
the generation of the customized design space information includes:
extracting a part of the options for each of the one or more factors; and
generating the customized design space information that includes the extracted part of the options for each of the one or more factors.

9. The control method according to claim 7,
the generation of the customized design space information includes:
acquiring predefined knowledge that represents a plurality of associations between characteristics of dataset and a design space of an architecture of a neural network;
extracting, from the predefined knowledge, the design space that is associated with the characteristics of dataset that matches the characteristics of the target dataset represented by the dataset characteristics information; and
generate the customized design space information based on the design space extracted from the predefined knowledge and the original design space represented by the original design space information.

10. The control method according to claim 7,
wherein the computer is configured to store a model that acquires the characteristics of the target dataset and outputs a design space in response to the characteristics of the target dataset being input into the model,
the generation of the customized design space information includes:
inserting the characteristics of the target dataset represented by the dataset characteristics information into the model;
acquire the design space output from the model;
generate the customized design space information based on the design space output from the model and the original design space represented by the original design space information.

11. The control method according to claim 7, further comprising:
acquiring a representative dataset having characteristics similar to or same as the characteristics of the target datasets; and
determining characteristics of the representative dataset to generate the dataset characteristics information that represents the determined characteristics of the representative dataset as the characteristics of the target dataset.

12. The control method according to claim 7,
wherein the characteristics of the target dataset includes a number of classes, a size of input data, a type of input data, a size of bounding box, a distribution of classes, a distribution of the size of input data, or a distribution of the size of bounding box.

13. A non-transitory computer-readable storage medium storing a program that causes a computer to perform:
acquiring original design space information representing an original design space of an architecture of a target neural network;
acquiring dataset characteristics information representing characteristics of a target dataset that is a collection of data to be analyzed by the target neural network; and
generating customized design space information representing a customized design space of the architecture of the target neural network using the original design space information and the dataset characteristics information, the customized design space being a design space narrower than the original design space.

14. The storage medium according to claim 13,
wherein the original design space information includes a plurality of options for each of one or more factors of the architecture of the target neural network;
the generation of the customized design space information includes:
extracting a part of the options for each of the one or more factors; and
generating the customized design space information that includes the extracted part of the options for each of the one or more factors.

15. The storage medium according to claim 13,
the generation of the customized design space information includes:
acquiring predefined knowledge that represents a plurality of associations between characteristics of dataset and a design space of an architecture of a neural network;
extracting, from the predefined knowledge, the design space that is associated with the characteristics of dataset that matches the characteristics of the target dataset represented by the dataset characteristics information; and
generate the customized design space information based on the design space extracted from the predefined knowledge and the original design space represented by the original design space information.

16. The storage medium according to claim 13, further storing:
a model that acquires the characteristics of the target dataset and outputs a design space in response to the characteristics of the target dataset being input into the model,
wherein the generation of the customized design space information includes:
inserting the characteristics of the target dataset represented by the dataset characteristics information into the model;
acquire the design space output from the model;
generate the customized design space information based on the design space output from the model and the original design space represented by the original design space information.

17. The storage medium according to claim 13,
wherein the program further causes the computer to perform:
acquiring a representative dataset having characteristics similar to or same as the characteristics of the target datasets; and
determining characteristics of the representative dataset to generate the dataset characteristics information that represents the determined characteristics of the representative dataset as the characteristics of the target dataset.

18. The storage medium according to claim 13,
wherein the characteristics of the target dataset includes a number of classes, a size of input data, a type of input data, a size of bounding box, a distribution of classes, a distribution of the size of input data, or a distribution of the size of bounding box.
